(19) United States
(12) Patent Application Publication
(10) Pub. No.: US 2008/0117010 A1
(43) Pub. Date: May 22, 2008

(54) IGNITION COIL AND METHOD OF MANUFACTURING THE SAME

(75) Inventors: Masahiro Ishitani, Obu-city (JP); Katsunori Akimoto, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/939,730

(22) Filed: Nov. 14, 2007

(30) Foreign Application Priority Data
Nov. 20, 2006 (JP) 2006-313140
Jul. 24, 2007 (JP) 2007-191777

(51) Int. Cl. H01F 27/24; H01F 27/28

(52) U.S. Cl. 336/90; 29/606; 336/177

(57) ABSTRACT

An ignition coil includes a primary coil and a secondary coil, a magnetic member through which a magnetic flux generated by the primary coil and the secondary coil passes, a resin case for accommodating therein the magnetic member, the primary coil and the secondary coil, and an insulating resin for filling the resin case. The magnetic member is formed by compression molding of a green compact material using iron-based powder including an insulating coating. In the ignition coil, the green compact material contains 50% by weight or more of the iron-based powder having a particle size about in a range of 150 μm to 300 μm. Alternatively, the green compact material has a content of a binder being 0.15% by weight or less.

### CROSS REFERENCE TO RELATED APPLICATION

This application is based on Japanese Patent Applications No. 2006-313140 filed on Nov. 20, 2006 and No. 2007-191777 filed on Jul. 24, 2007, the contents of which are incorporated herein by reference in its entirety.

### FIELD OF THE INVENTION

The present invention relates to an ignition coil for an internal combustion engine, and a method of manufacturing the same.

### BACKGROUND OF THE INVENTION

In an ignition coil used in an internal combustion engine, a magnetic member (coil core) through which a magnetic flux generated by a primary coil and a secondary coil passes is generally formed by stacking multiple silicon steel plates. In contrast, another ignition coil is proposed in which a center core disposed on the center side of the primary coil and the secondary coil is a powder-pressed core made of powder compact material (i.e., green compact material), as disclosed in, for example, JP-A 2006-278499. In this document, the powder-pressed core is formed by use of a first soft magnetic material made of iron-based powder, and a second soft magnetic material made of permendur, which is an alloy of iron and cobalt. Furthermore, the second soft magnetic material has a saturation magnetic flux density of 2.0 (T) or more so as to improve the output characteristics of the ignition coil.

However, further efforts will be required to improve the magnetic flux density of the coil core by use of the iron-based powder without using the permendur.

### SUMMARY OF THE INVENTION

The present invention has been accomplished in view of the above-described problems, and it is an object of the present invention to provide an ignition coil, which can reinforce the strength of a magnetic member using iron-based powder, while effectively improving the magnetic flux density of the magnetic member.

It is another object of the present invention to provide a method of manufacturing the ignition coil.

According to an aspect of the present invention, an ignition coil includes a primary coil and a secondary coil, a magnetic member through which a magnetic flux generated by the primary coil and the secondary coil passes, a resin case for accommodating therein the magnetic member, the primary coil and the secondary coil, and an insulating resin for filling the resin case. Furthermore, the magnetic member is formed by compression molding of a green compact material using iron-based powder including an insulating coating In the ignition coil, the green compact material contains 50% by weight or more of the iron-based powder having a particle size about in a range of 150 μm to 300 μm.

The magnetic member is formed by compression molding of the green compact material mainly including the iron-based powder (in an amount of about 99% by weight or more) covered with the insulating coating. For example, a Fe—Si alloy powder having its surface covered with an insulating resin coating can be used as the iron-based powder.

In the ignition coil, the green compact material contains 50% by weight or more of the iron-based powder having the particle size of 150 to 300 μm. This can effectively increase the rate of the iron-based powder in the magnetic member. Also when the iron-based powder is used as the green compact material, the magnetic flux density of the magnetic member can be effectively improved. Furthermore, a clearance in the resin case having therein the magnetic member can be filled with an insulating resin. Thus, the insulating resin can hold the magnetic member in the shape formed in the compression molding, thereby reinforcing the magnetic member.

According to another aspect of the present application, the green compact material may have a content of a binder being 0.15% by weight or less. Therefore, the rate of the iron-based powder in the magnetic member can be increased relatively Even in this case, the magnetic flux density of the magnetic member can be effectively improved.

The binder content may be 0% by weight, as an example. That is, the green compact material may be made of only the iron-based powder without containing the binder. Even in this case, the clearance in the resin case having therein the magnetic member can be filled with the insulating resin. This can hold the magnetic member in the shape formed in the compression molding by the insulating resin, thereby reinforcing the magnetic member.

According to another aspect of the present invention, a method of manufacturing an ignition coil includes a step of arranging a primary coil and a secondary coil in a resin case, a step of forming a magnetic member in the resin case such that a magnetic flux generated by the primary coil and the secondary coil passes through the magnetic member; and a step of filling a clearance in the resin case after the arranging and the forming. Furthermore, the step of the forming includes a step of compression molding of a green compact material using iron-based powder having an insulating coating. Furthermore, the green compact material contains 50% by weight or more of the iron-based powder having a particle size about in a range of 150 μm to 300 μm, or the green compact material has a content of a binder being 0.15% by weight or less. Accordingly, by the method of the ignition coil, the magnetic member with the assured strength and with the improved magnetic flux density can be provided using the iron-based powder.

For example, the magnetic member may have a magnetic flux density of 1.7 T (teslas) or more, and more preferably, a magnetic flux density of 1.8 T (teslas) or more when a magnetic force of 10 kA/m is applied to the magnetic member. Alternatively, a specific resistance of the magnetic member may be 10 μΩm or more, and a density of the magnetic member is 7.7 g/cm³ or more. More preferably, the specific resistance of the magnetic member may be 20 μΩm or more.

In the method of manufacturing the ignition coil, the compression molding can be performed such that the particle size of the iron-based powder is not substantially changed in the magnetic member.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a schematic sectional view showing an ignition coil of a first example in an embodiment of the present invention;

FIG. 2 is a schematic sectional view showing an ignition coil of a second example in the embodiment of the present invention; and

FIG. 3 is a schematic sectional view showing an ignition coil of a third example in the embodiment of the present invention.

### DETAILED DESCRIPTION OF PREFERRED EMBODIMENTS

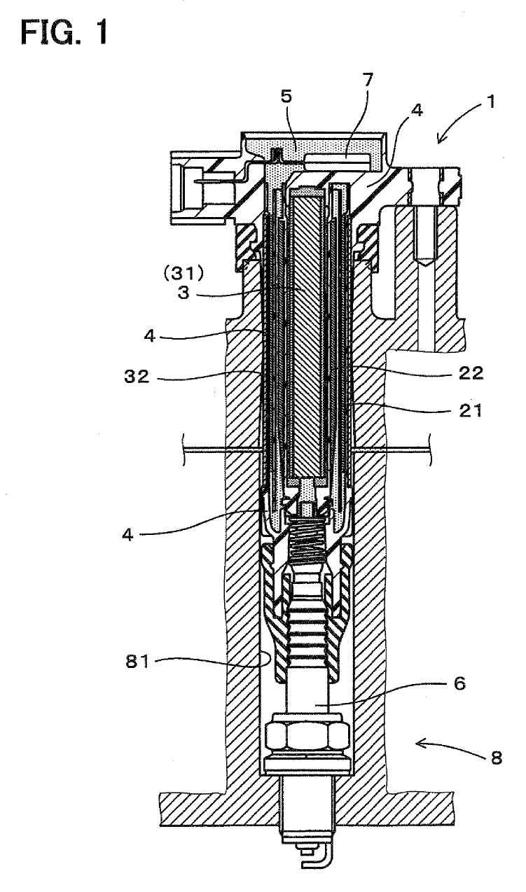

An embodiment of the present invention will be now described with reference to FIGS. 1 to 3. In this embodiment, the present invention is typically used for ignition coils of three examples shown in FIGS. 1 to 3.

An ignition coil 1 of the first example shown in FIG. 1 will be now described. The ignition coil 1 is for generating a spark between a pair of electrodes of a spark plug in an internal combustion engine, for example.

As shown in FIG. 1, the ignition coil 1 in the first example includes a primary coil 21, a secondary coil 22, a magnetic member 3 through which a magnetic flux generated by the primary coil 21 and the secondary coil 22 passes, a resin case 4 for accommodating therein the magnetic member 3, the primary coil 21 and the secondary coil 22, and an insulating resin 5 filling the resin case 4.

The magnetic member 3 is formed by compression molding of a green compact material (i.e., powder compact material) using an iron-based powder including insulating coatings. The green compact material contains 50% by weight or more of the iron-based powder having the particle size of 150 to 300 μm. A binder content in the green compact material is 0.15% by weight or less in the embodiment.

The ignition coil 1 in the first example, as shown in FIG. 1, is of a stick type in which a coil portion including the primary coil 21 and the secondary coil 22 is disposed in a plughole 81 of an engine 8. A center core 31 made of a soft magnetic material is disposed on the inner peripheral side of the primary coil 21 and the secondary coil 22, while a circumferential core 32 made of a soft magnetic material is disposed on the outer peripheral side of the primary coil 21 and the secondary coil 22.

The primary coil 21, the secondary coil 22, the center core 31, and the circumferential core 32 are disposed in the resin case 4 (coil case) made of a thermoplastic resin. Then, a clearance in the resin case 4 is filled with epoxy resin as the insulating resin 5.

An igniter 7 for energizing of the primary coil 21 or interrupting energization thereof is disposed on the upper end of the ignition coil 1. A spark plug 6 is attached to the lower end of the ignition coil 1, for generating a spark using a high-voltage current created by the secondary coil 22.

A conductive pin derived from the igniter 7 is electrically connected to an electronic control unit (ECU) of the engine 8 via a wiring harness.

As shown in FIG. 1, the primary coil 21 is formed by winding a primary wiring covered with an insulating coating around a primary spool in an annular sectional shape. The secondary coil 22 is formed by winding a secondary wiring covered with an insulating coating around a secondary spool in an annular sectional shape. The primary spool and the secondary spool can be made of a thermoplastic resin material, for example. The secondary wiring has a smaller diameter than that of the primary wiring, and thus the secondary wiring is wound around the secondary spool more times than that of the primary wiring.

In the first example of FIG. 1, the magnetic member 3 formed by the compression molding of the above green compact material is used for the center core 31 described above. The center core 31 is formed in a cylindrical shape by the compression molding. Alternatively, the magnetic member 3 formed by the compression molding of the above green compact material can be used for the circumferential core 32. The magnetic member 3 formed by the compression molding of the above green compact material can also be used for a relay core (not shown) for relaying an end in the axial direction of the center core 31 to an end in the axial direction of the circumferential core 32.

The green compact material as one example may do not contain a binder. In this case, the green compact material can be formed only of the iron-based powder covered with the insulating coatings.

The magnetic member 3 in the first example of FIG. 1 is manufactured by compression molding of the green compact material, which contains 50% by weight or more of the iron-based powder having the particle size of 150 to 300 μm, and 0.15% by weight or less of the binder. Even after the compression molding, the particle size of the iron-based powder is not substantially changed, so that the content of the iron-based powder having the particle size of 150 to 300 μm in the magnetic member 3 results in 50% by weight or more.

When current is applied to the primary coil 21 in response to a pulse-like signal for generating a spark from the ECU in the ignition coil 1 a magnetic field passing through the center core 31 and the circumferential core 32 is formed. When the current applied to the primary coil 21 is interrupted, a voltage is generated in the primary coil 21 by a self-induction effect, while a high-voltage induced electromotive force is generated in the secondary coil 22 by a mutual induction effect, so that the spark can be generated between a pair of electrodes in the spark plug 6 attached to the ignition coil 1.

In the ignition coil 1 in this example of FIG. 1, the magnetic member 3 used as the center core 31 is formed by compression molding of the green compact material mainly containing the iron-based powder (in an amount of 99% by weight or more) including the insulating coatings. The content of the iron-based powder having the particle size of 150 to 300 μm in the green compact material is 50% by weight or more, and the content of the binder in the green compact material is 0.15% by weight or less. This can effectively increase the rate of the iron-based powder exhibiting a magnetizing force in the magnetic member 3. Even when the iron-based powder is used as the green compact material, the magnetic flux density of the magnetic member 3 can be improved more effectively.

The extremely small content of the binder as mentioned above may lower the strength of bonding between the powder particles, resulting in reduced strength of the magnetic member 3. In contrast, in this example of FIG. 1, the clearance in the resin case 4 is filled with the insulating resin 5, after the primary coil 21, the secondary coil 22 and the magnetic member 3 are accommodated in the resin case 4. This can hold the magnetic member 3 in the shape formed in the compression molding by the insulating resin 5, thereby reinforcing the magnetic member 3.

Accordingly, the ignition coil 1 and the manufacturing method in the first example can compensate for reduction in strength of the magnetic member 3 when forming the magnetic member 3 mainly using the iron-based powder, thereby effectively improving the magnetic flux density of the magnetic member 3.

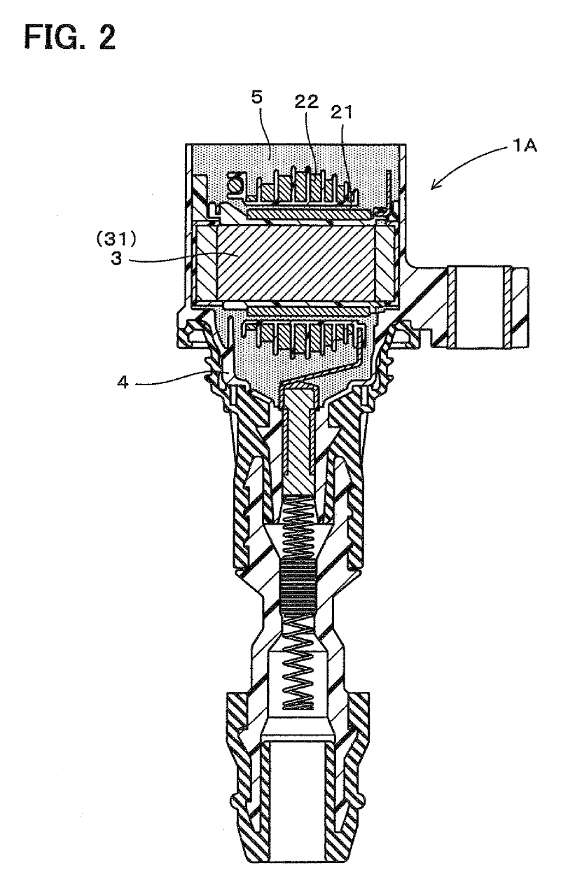

The magnetic member 3 formed using the above-mentioned green compact material can be applied to cores, such as the center core 31, the circumferential core 32, and a relay core, in the ignition coil 1 of the stick type, but the invention is not limited thereto. FIG. 2 shows an ignition coil 1A of the second example, for which the magnetic member 3 of the present embodiment is used. As shown in FIG. 2, the magnetic member 3 can also be used for the ignition coil 1A of a rectangular type, which has a primary coil 21 and a secondary coil 22 disposed outside the plughole 81 of the engine 8. In the second example of FIG. 2, the parts having the same functions as those of the first example are indicated by the same reference numbers, and detail description thereof is omitted.

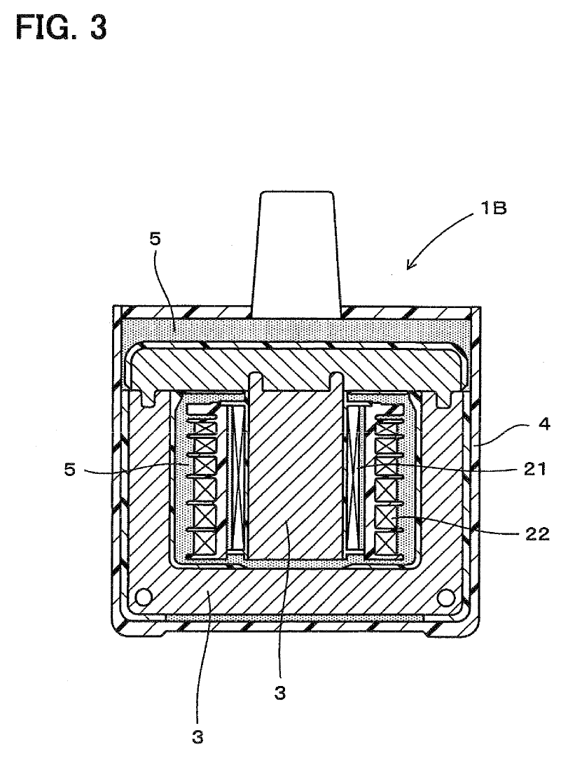

Furthermore, the magnetic member 3 formed using the above green compact material can also be used for an ignition coil 1B shown in FIG. 3. The ignition coil 1B includes a primary coil 21, a secondary coil 22 and a closed magnetic circuit core. The closed magnetic circuit core formed of the magnetic member 3 connects the inner peripheral side, both end sides in the axial direction, and the outer peripheral side of the primary coil 21 and the secondary coil 22, as shown in FIG. 3. In the third example of FIG. 3, the parts having the same functions as those of the first example are indicated by the same reference numbers, and detail description thereof is omitted.

### (Magnetic Characteristics)

Next, the magnetic characteristics of the magnetic member 3 used for the ignition coil 1, 1A, 1B will be described.

As one example of the present invention, the magnetic member 3 is manufactured using an green compact material, in which the content of iron-based powder having the particle size of 150 to 300 μm was 50% by weight or more, and the content of a binder was 0% by weight. The average particle size of the iron-based powder constituting the green compact material of the one example was determined to be about 200 μm. In this state, the magnetic characteristics of the magnetic member 3 are measured. For comparison, magnetic characteristics of a magnetic member in a comparison example are measured. In the comparison example, the magnetic member is manufactured using a green compact material in which the content of the iron-based powder having the particle size of 50 to 150 μm was 50% by weight or more, and the content of the binder was 0.6% by weight. The average particle size of the iron-based powder particles constituting the green compact material in the comparison example was determined to be about 100 μm.

In the one example of the present invention and in the comparison example, Fe—Si alloy powder particles coated with resin insulating coatings were used as the iron-based powder.

Then, the magnetic characteristics are exampled in the one example of the present invention and the comparison example as in Table 1. Table 1 shows the results of the magnetic characteristics including direct current magnetic characteristics and an alternating current magnetic characteristic. The direct current magnetic characteristics include: a density of the magnetic member (g/cm³); a specific resistance of the magnetic member (μΩm); a magnetic flux density (T) (B 10 k) of the magnetic member when a holding power of 10 kA/m (magnetic field) is applied; and a maximum dielectric constant (μm). The alternating current magnetic characteristic includes a core loss (iron loss) of the magnetic member (W/kg), under the condition of a frequency of 400 HZ and of a magnetic flux density of 1 T.

TABLE 1

| | DC magnetic characteristics | | | | AC magnetic |
|---|---|---|---|---|---|
| | | | | Maximum | characteristic |
| | | Specific | Magnetic | dielectric | Core loss |
| | Density | resistance | flux density | constant | (W/kg) |
| | (g/cm³) | (μΩm) | B10k (T) | (μm) | (1 T/400 HZ) |
| One | 7.75 | 20 | 1.8 | 900 | 58 |
| Example of | | | | | |
| Invention | | | | | |
| Comparison | 7.5 | 1200 | 1.64 | 410 | 68 |
| example | | | | | |

As shown in Table 1, it was confirmed that in the one example of the present invention, the density of the magnetic member can be 7.7 g/cm³ or more, and the magnetic flux density thereof can be 1.8 T or more, which can be larger than those in the comparison example. Also, the maximum dielectric constant of the magnetic member in the one example of the present invention can be larger than that in the comparison example.

It has found that the specific resistance of the magnetic member in the one example of the present invention was 20 μΩm, which was small as compared to that in the comparison example, but is sufficient to reduce the core loss (hysteresis loss and overcurrent loss).

As to the alternating current magnetic characteristic, it was confirmed that the one example in the present invention was superior to the comparison example.

In the one example of the present invention, the magnetic member 3 is formed using the green compact material in which the content of the iron-based powder having the particle size of 150 to 300 μm is 50% by weight or more, and the content of the binder is 0% by weight. In this case, it can effectively improve the magnetic flux density of the magnetic member 3 as compared with the comparison example shown in Table 1.

Although the present invention has been fully described in connection with the ignition coil 1, 1A and 1B of the first to third examples with reference to the accompanying FIGS. 1 to 3, it is to be noted that various changes and modifications will become apparent to those skilled in the art.

The present invention can be used for any an ignition coil that includes: a primary coil 21 and a secondary coil 22; a magnetic member 3 through which a magnetic flux generated by the primary coil 21 and the secondary coil 22 passes; a resin case 4 for accommodating therein the magnetic member 3, the primary coil 21, and the secondary coil 22; and an insulating resin 5 for filling the resin case 4. In the ignition coil, the magnetic member 3 can be formed by compression molding of a green compact material using iron-based powder including an insulating coating. According to an aspect of the present invention, the green compact material contains 50% by weight or more of the iron-based powder having a particle size about in a range of 150 μm to 300 μm. Therefore, it can effectively increase the rate of the iron-based powder in the magnetic member 3. Also because the iron-based powder is used as the green compact material, the magnetic flux density of the magnetic member 3 can be effectively improved.

The above-mentioned magnetic member 3 is formed by compression molding of the green compact material mainly including the iron-based powder (in an amount of 99% by weight or more) covered with the insulating coating. For example, a Fe—Si alloy powder having its surface covered with an insulating resin coating can be used as the iron-based powder.

Because a clearance in the resin case 4 is filled with an insulating resin 5 with the magnetic member accommodated in the resin case 4, the insulating resin 5 can hold the magnetic member 3 in the shape formed in the compression molding, thereby reinforcing the magnetic member 3.

According to another aspect of the present invention, the binder content of the green compact material is 0.15% by weight or less. The binder content may be 0% by weight, for example. This can increase relatively the rate of the iron-based powder in the magnetic member 3. Also when the iron-based powder is used as the green compact material, the magnetic flux density of the magnetic member 3 can be effectively improved.

The extremely small content of the binder as mentioned above may lower the strength of bonding between the powder particles, resulting in reduced strength of the magnetic member. However, in the present invention, the clearance in the resin case 4 is filled with the insulating resin 5 after the magnetic member 3 is accommodated in the resin case 4. This can hold the magnetic member 3 in the shape formed in the compression molding by the insulating resin 5, thereby reinforcing the magnetic member 3.

In the above-described embodiment, the content of iron-based powder having a particle size of 150 to 300 μm in the magnetic member 3 is substantially the same as that of the iron-based powder having the particle size of 150 to 300 μm in a green compact material before the compression molding. The compression molding is performed using the green compact material containing 50% by weight of the iron-based powder having the particle size of 150 to 300 μm to manufacture the above-mentioned magnetic member 3. The particle size of the iron-based powder of the green compact material used in manufacturing of the magnetic member 3 can be determined by a classification weight of a sieve in a normal mass production inspection.

The particle size of the iron-based powder contained in the magnetic member 3 can be defined by observing a section of the magnetic member 3 cut. Specifically, the magnetic member 3 is cut, and the section cut is polished (mirror-polished). Then, the cut section is observed in visual fields with a microscope, and image processing (executed by using software or the like) is performed, thereby enabling measurement (defining) of a particle size of the iron-based powder in the magnetic member 3.

It is supposed that since all iron-based powder particles are not cut in the center positions and some iron-based powder particles may be cut at ends thereof, a particle size of the iron-based powder on the cut section can be measured to be slightly smaller than the actual diameter of the powder. For this reason, specifically, iron-based powder particles having particle sizes in various ranges are compressed and molded to form the magnetic member 3. Then, the magnetic member 3 is cut, and the distribution state of the particle sizes of the iron-based powder particles is measured to determine a correction coefficient. The use of the correction coefficient can determine the distribution of actual particle sizes of the iron-based powder particles of the magnetic member 3.

In the ignition coil 1, 1A, 1B, the magnetic member 3 may be set to have a magnetic flux density of 1.7 T (teslas) or more when a magnetic force of 10 kA/m is applied to the magnetic member 3. Furthermore, the magnetic member 3 can be set to have a magnetic flux density of 1.8 T (teslas) or more when the magnetic force of 10 kA/m is applied to the magnetic member 3.

In the ignition coil 1, 1A, 1B, the green compact material can be made of only the iron-based powder without containing the binder. Even in this case, the effect of enabling reinforcement of the magnetic member 3 by the above-mentioned insulating resin 5 can prevent the magnetic member 3 from breaking, and hold the magnetic member 3 in a shape formed in the compression molding even when the green compact material is constructed only of the above-mentioned iron-based powder. In this case, the magnetic flux density of the magnetic member 3 can be improved more effectively.

In the ignition coil 1, 1A, 1B of the above-described examples, a specific resistance of the magnetic member 3 may be set at 10 μΩm or more, and a density of the magnetic member 3 may be set at 7.7 g/cm³ or more, when the green compact material contains 50% by weight or more of the iron-based powder having a particle size about in a range of 150 μm to 300 μm or the green compact material has a content of a binder being 0.15% by weight or less. More preferably, the specific resistance of the magnetic member 3 can be set at 20 μΩm or more. The density of iron is 7.86 g/cm³, so that the density of the magnetic member 3 can be set as close as possible to the density of the iron.

Such changes and modifications are to be understood as being within the scope of the present invention as defined by the appended claims.

What is claimed is:

1. An ignition coil comprising:
a primary coil and a secondary coil;
a magnetic member through which a magnetic flux generated by the primary coil and the secondary coil passes;
a resin case for accommodating therein the magnetic member, the primary coil, and the secondary coil; and
an insulating resin for filling the resin case,
wherein the magnetic member is formed by compression molding of a green compact material using iron-based powder including an insulating coating, and
wherein the green compact material contains 50% by weight or more of the iron-based powder having a particle size about in a range of 150 μm to 300 μm.

2. An ignition coil comprising:
a primary coil and a secondary coil;
a magnetic member through which a magnetic flux generated by the primary coil and the secondary coil passes;
a resin case for accommodating therein the magnetic member, the primary coil, and the secondary coil; and
an insulating resin for filling the resin case,
wherein the magnetic member is formed by compression molding of a green compact material using iron-based powder including an insulating coating, and
wherein the green compact material has a content of a binder being 0.15% by weight or less.

3. The ignition coil according to claim 1, wherein the green compact material has a content of a binder being 0.15% by weight or less.

4. The ignition coil according to claim 1, wherein the magnetic member has a magnetic flux density of 1.7 T (teslas) or more when a magnetic force of 10 kA/m is applied to the magnetic member.

5. The ignition coil according to claim 3, wherein the magnetic member has a magnetic flux density of 1.8 T (teslas) or more when the magnetic force of 10 kA/m is applied to the magnetic member.

6. The ignition coil according to claim 1, wherein the green compact material is made of only the iron-based powder without containing the binder.

7. The ignition coil according to claim 1, wherein a specific resistance of the magnetic member is 10 μΩm or more, and a density of the magnetic member is 7.7 g/cm³ or more.

8. A method of manufacturing an ignition coil, comprising:
arranging a primary coil and a secondary coil in a resin case;
forming a magnetic member in the resin case such that a magnetic flux generated by the primary coil and the secondary coil passes through the magnetic member; and
filling a clearance in the resin case with an insulating resin after the arranging and the forming,
wherein the forming includes compression molding of a green compact material using iron-based powder having an insulating coating,
wherein the green compact material contains 50% by weight or more of the iron-based powder having a particle size about in a range of 150 μm to 300 μm.

9. A method of manufacturing an ignition coil, comprising:
arranging a primary coil and a secondary coil in a resin case;
forming a magnetic member in the resin case such that a magnetic flux generated by the primary coil and the secondary coil passes through the magnetic member; and
filling a clearance in the resin case with an insulating resin after the arranging and the forming,
wherein the forming includes compression molding of a green compact material using iron-based powder having an insulating coating, and
wherein the green compact material has a content of a binder being 0.15% by weight or less.

10. The method according to claim 8, wherein the compression molding is performed such that the particle size of the iron-based powder is not substantially changed in the magnetic member.

11. The method according to claim 8, wherein the magnetic member is formed such that the magnetic member has a magnetic flux density of 1.7 T (teslas) or more when a magnetic force of 10 kA/m is applied to the magnetic member.

12. The method according to claim 11, wherein the magnetic member is formed such that the magnetic member has a magnetic flux density of 1.8 T (teslas) or more when the magnetic force of 10 kA/m is applied to the magnetic member.

13. The method according to claim 8, wherein the magnetic member is formed using the green compact material that is made of only the iron-based powder without containing the binder.

14. The method according to claim 8, wherein the magnetic member is formed such that a specific resistance of the magnetic member is 10 μΩm or more, and a density of the magnetic member is 7.7 g/cm³ or more.

15. The method according to claim 8, wherein the magnetic member is formed such that a specific resistance of the magnetic member is 20 μΩm or more, and a density of the magnetic member is 7.7 g/cm³ or more.
